(19) United States
(12) Patent Application Publication
(10) Pub. No.: US 2016/0321318 A1
(43) Pub. Date: Nov. 3, 2016

(54) SERVICE PROVIDER DEPENDENCY MAPPING

(71) Applicant: HEWLETT-PACKARD DEVELOPMENT COMPANY, L.P., Houston, TX (US)

(72) Inventors: Emil Shmul, Yehud (IL); David Azriel, Yehud (IL); Genadi Rabinovich, Yehud (IL); Haya Axelrod, Yehud (IL)

(21) Appl. No.: 14/700,537

(22) Filed: Apr. 30, 2015

(51) Int. Cl. G06F 17/30; H04L 29/08; H04L 29/12

(52) U.S. Cl. CPC G06F 17/30377; H04L 61/2007; H04L 67/16; G06F 17/30091; G06F 17/30106

(57) ABSTRACT

Examples disclosed herein relate to dependency mapping instructions to identify a plurality of service provider instances, identify a plurality of consumer instances, determine, according to a correlation between a configuration setting for each of the service provider instances and a configuration file for each of the plurality of consumer instances, whether one of the plurality of consumer instances is dependent on one of the plurality of service provider instances, and update a dependency map comprising the dependency of the one of the plurality of consumer instances on the one of the plurality of service provider instances.

### BACKGROUND

Dependency mapping allows for the identification and tracking of dependencies between service provider instances and consumer instances. For example, a server may offer three instances of a database service provider to which consumer instances may connect, thereby creating a dependency between each consumer instance and the particular database instance with which it interacts.

### BRIEF DESCRIPTION OF THE DRAWINGS

In the accompanying drawings, like numerals refer to like components or blocks. The following detailed description references the drawings, wherein:

FIG. 1 is a block diagram of an example dependency mapping device;

FIG. 2 is a flowchart of an example of a method for dependency mapping; and

FIG. 3 is a block diagram of an example system for dependency mapping.

### DETAILED DESCRIPTION

As described above, dependency mapping may identify dependency links between consumer instances and service provider instances. Service provider and consumer instances may comprise, for example, applications, services, application and software components, such as database schemas and/or Web Application (WAR) components, and/or running software instances, such as a web server or application server (e.g., a JBOSS application server). Each service provider instance may be associated with a particular configuration setting, such as a connection string, that may be extracted and searched for in each consumer instances configuration information. By identifying a particular service provider instance's IP address and port number in a configuration file for a specific consumer instance, the link between consumer and service provider may be identified and a dependency between them tracked in a map of a plurality of similar dependencies.

In the description that follows, reference is made to the term, “non-transitory machine-readable storage medium.” As used herein, the term “non-transitory machine-readable storage medium” refers to any electronic, magnetic, optical, or other physical storage device that stores executable instructions or other data (e.g., a hard disk drive, random access memory, flash memory, etc.).

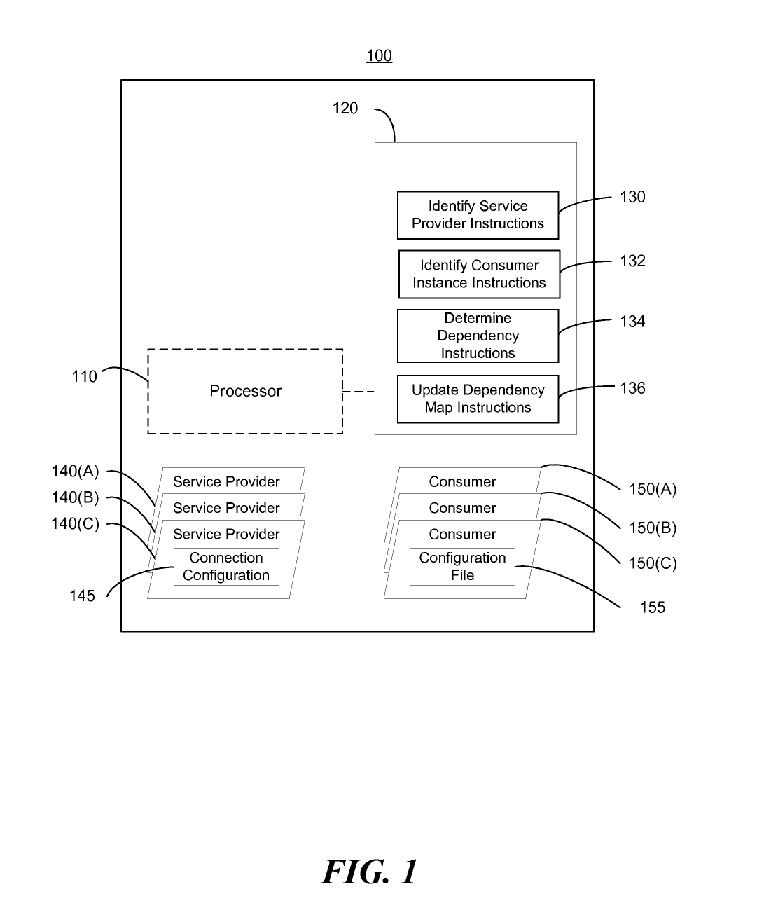

Referring now to the drawings, FIG. 1 is a block diagram of an example dependency mapping device 100 consistent with disclosed implementations. Dependency mapping device 100 may comprise a processor 110 and a non-transitory machine-readable storage medium 120. Dependency mapping device 100 may comprise a computing device such as a server computer, a desktop computer, a laptop computer, a handheld computing device, a smart phone, a tablet computing device, a mobile phone, or the like.

Processor 110 may comprise a central processing unit (CPU), a semiconductor-based microprocessor, or any other hardware device suitable for retrieval and execution of instructions stored in machine-readable storage medium 120. In particular, processor 110 may fetch, decode, and execute a plurality of identify service provider instructions 130, identify consumer instance instructions 132, determine dependency instructions 134, and update dependency map instructions 136 to implement the functionality described in detail below.

Executable instructions may be stored in any portion and/or component of machine-readable storage medium 120. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Dependency mapping device 100 may further comprise a plurality of service provider instances 140(A)-(C) and a plurality of consumer instances 150(A)-(C). Service provider instances 140(A)-(C) and/or consumer instances 150(A)-(C) may comprise actively executing applications, services, threads, processes, or the like, each of a given service provider type or consumer type, respectively. For example, a SQL database service provider type may be associated with multiple service provider instances, wherein each instance may be associated with its own set of data, configuration settings, and/or connection information. Similarly, a web client type may be executed in multiple consumer instances, such as for individual web client sessions, each of which may connect to one and/or more service provider instances.

Each service provider instance may comprise a connection configuration 145 identifying connection settings and/or strings for interacting with service provider instances 140(A)-(C). For example, service provider instance 140(C) may comprise connection configuration 145 specifying that instance 140(C) may be contacted at IP address 1.1.1.1, port 8080, and expects a session ID beginning with SQLDB-C. Each of service provider instances 140(A)-(C) may be associated with its own respective connection configuration, though only one is shown here for ease of reference.

Each consumer instance may comprise a configuration file 155. As referred to herein, configuration file 155 may comprise a file stored on device 100 and/or may refer to configuration variables associated with consumer instances 150(A)-(C), configuration information stored in a database, configuration information stored in volatile memory, and/or configuration information stored in a remote and/or networked location. Configuration file 155 may provide the connection settings for consumer instance 150(C) to connect to service provider 140(C), for example. Each of consumer instances 150(A)-(C) may be associated with its own respective configuration file, though only one is shown here for ease of reference.

Identify service provider instructions 130 may identify a plurality of service provider instances. For example, service provider types such as web servers, databases, middleware engines, directory services, etc. may be available on a server. Each of the service provider types may be associated with one and/or more service provider instances 140(A)-(C). In some implementations, a list of service provider types and/or service provider instances may be stored in configuration settings associated with identify service provider instructions 130. In some implementations, identify service provider instructions may search active processes on the server to identify which service provider instances are active.

In some implementations, identify service provider instructions 130 may extract a respective connection string from a configuration file associated with each of the plurality of service provider instances. Each service provider instance 140(A)-(C) may be associated with configuration settings such as connection strings, required parameters, identifiers, etc. The connection string may comprise, for example, an IP address and port at which consumer instance 150(A)-(C) may communicate with the service provider instances 140(A)-(C). In some implementations, the configuration settings may, for example, be stored in a configuration file at a location known to be associated with the service provider type, such as an httpd.conf file stored in an /etc/httpd/ directory. Such locations may comprise general configuration file directories for a server and/or may be service provider instance, service provider type, server, and/or operating system specific. In some implementations, the configuration settings and/or connection string information may be stored in other locations such as registry entries, database tables, multiple provider configuration files, etc. The configuration settings may be extracted by, for example, read operations on the configuration files and/or other protocols such as Simple Network Management Protocol (SNMP) traps, Secure Shell (SSH) and Secure Copy (SCP) operations, JAVA Management Extensions (JMX), Object Linking and Embedding (OLE), and/or database connections such as JAVA Database Connectivity (JDBC) and/or SQL.

In some implementations, identify service provider instructions 130 may create a required relationship between the IP address and the port number. For example, the IP address and port may be associated such that both elements may comprise required search parameters.

Identify consumer instance instructions 132 may identify consumer instances 150(A)-(C) that interact with service provider instances 140(A)-(C). In some implementations, a list of consumer types and/or consumer instances may be stored in configuration settings associated with identify consumer instructions 130. In some implementations, identify consumer instructions may search active processes on the server to identify which consumer instances are actively communicating with service provider instances 140(A)-(C). For example, several web-based applications may comprise consumer instances 150(A)-(C) and depend on a web server type service provider instance 140(B). For another example, several compiled applications may communicate with and depend upon a database type service provider instance 140(C). In some implementations, the configuration files for consumer instances 150(A)-(C) may be indexed into a database compatible with a text search algorithm.

Determine dependency instructions 134 may determine, according to a correlation between a configuration setting for each of the service provider instances and a configuration file for each of the plurality of consumer instances, whether one of the plurality of consumer instances is dependent on one of the plurality of service provider instances. In some implementations, determine dependency instruction 134 may search configuration files for one and/or more of consumer instances 150(A)-(C) to identify candidate consumers of a given service provider instance.

Determine dependency instructions 134 may generate a search command such as “Get all config-documents containing one-of(IPs) AND database_port AND database_sid” for a database type service provider wherein “IPs”, “database_port” and “database_sid” comprise variables to be replaced with configuration information extracted from each service provider instance's respective configuration settings. A database instance may comprise a connection string of 1.1.1.1:8080 with a session id (SID) of SQLDB-C. The search command may be updated with these values and the search “Get all config-documents containing one-of(1.1.1.1) AND 8080 AND SQLDB-C” may be run against the configuration files for consumer instances 150(A)-(C). In some implementations, the search command may use regular expressions and/or other search syntax such as may be compatible with an indexed database of consumer instance configuration files.

Update dependency map instructions 136 may, in response to determining that one of the plurality of consumer instances is dependent on the one of the plurality of service provider instances, update a dependency map comprising the dependency of the one of the plurality of consumer instances on the one of the plurality of service provider instances. For example, update dependency map instructions may create a new entry associating consumer instance 150(A) with service provider instance 140(B) when the connection string from service provider instance 140(B) is located in the configuration file for consumer instance 150(A).

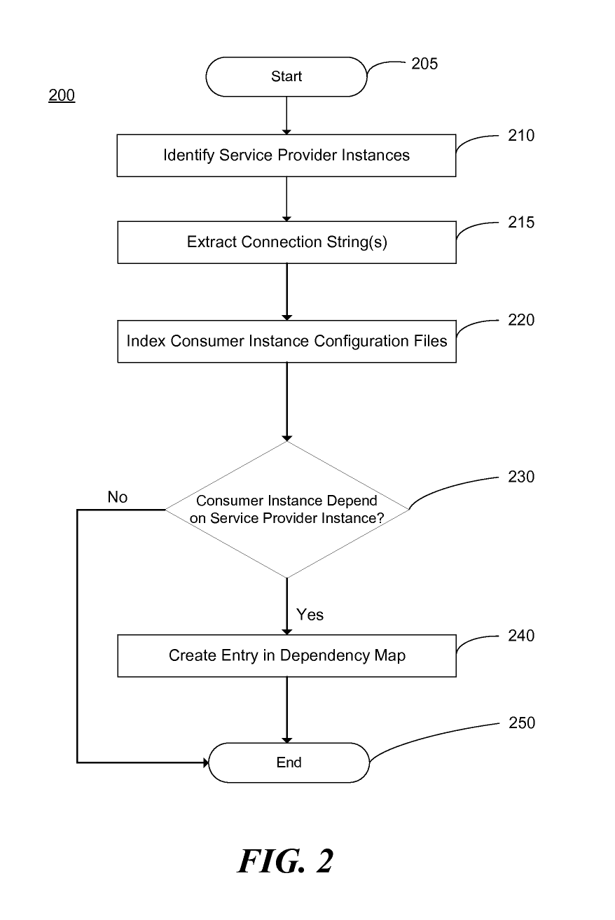

FIG. 2 is a flowchart of an example of a method 200 for dependency mapping consistent with disclosed implementations. Although execution of method 200 is described below with reference to the components of dependency mapping device 100, other suitable components for execution of method 200 may be used.

Method 200 may start in block 205 and proceed to block 210 where device 100 may identify a plurality of service provider instances. In some implementations, identify service provider instructions 130 may identify a plurality of service provider instances. For example, service provider types such as web servers, databases, middleware engines, directory services, etc. may be available on a server. Each of the service provider types may be associated with one and/or more service provider instances 140(A)-(C).

In some implementations, a list of service provider types and/or service provider instances may be stored in configuration settings associated with identify service provider instructions 130. In some implementations, identify service provider instructions may search active processes on the server to identify which service provider instances are active.

Method 200 may proceed to block 215 where device 100 may extract a connection string for at least one of the plurality of service provider instances. In some implementations, identify service provider instructions 130 may extract a respective connection string from a configuration file associated with each of the plurality of service provider instances. Each service provider instance 140(A)-(C) may be associated with configuration settings such as connection strings, required parameters, identifiers, etc.

The connection string may comprise, for example, an IP address and port at which consumer instances 150(A)-(C) may communicate with the service provider instances 140(A)-(C). The configuration settings may, for example, be stored in a configuration file at a location known to be associated with the service provider type, such as an httpd.conf file stored in an /etc/httpd/ directory. Such locations may comprise general configuration file directories for a server and/or may be service provider instance, service provider type, server, and/or operating system specific.

In some implementations, identify service provider instructions 130 may create a required relationship between the IP address and the port number. For example, the IP address and port may be associated such that both elements may comprise required search parameters.

In some implementations, the connection string for the at least one of the plurality of service provider instances may be extracted from a standard location according to a type of the at least one of the plurality of service provider instances.

Method 200 may proceed to block 220 where device 100 may index a plurality of consumer instance configuration files. For example, identify consumer instance instructions 132 may identify consumer instances 150(A)-(C) that interact with service provider instances 140(A)-(C). In some implementations, a list of consumer types and/or consumer instances may be stored in configuration settings associated with identify consumer instructions 130. In some implementations, identify consumer instructions may search active processes on the server to identify which consumer instances are actively communicating with service provider instances 140(A)-(C). For example, several web-based applications may comprise consumer instances 150(A)-(C) and depend on a web server type service provider instance 140(B). For another example, several compiled applications may communicate with and depend upon a database type service provider instance 140(C). In some implementations, the configuration files for consumer instances 150(A)-(C) may be indexed into a database compatible with a text search algorithm.

Method 200 may proceed to block 230 where device 100 may determine whether a consumer instance is dependent on the at least one of the plurality of service provider instances according to a search for the connection string in the indexed plurality of consumer instance configuration files. In some implementations, determine dependency instructions 134 may determine, according to a correlation between a configuration setting for each of the service provider instances and a configuration file for each of the plurality of consumer instances, whether one of the plurality of consumer instances is dependent on one of the plurality of service provider instances. In some implementations, determine dependency instructions 134 may search configuration files for one and/or more of consumer instances 150(A)-(C) to identify candidate consumers of a given service provider instance.

In some implementations, device 100 may provide each of the configuration files to a text-search engine. A search engine may comprise an information retrieval system providing an interface enabling criteria in the form of a search expression to be supplied. The search engine applies the criteria to each stored item to retrieve a list of each item matching the criteria. Search expressions may comprise terms as well as operators. For example, a search expression may comprise the terms “1.1.1.1” and “8080” with the operator “AND”, indicating that both terms should be present for any given item to be considered a successful match. The search expression may thus be applied to the search engine to efficiently identify those configuration files that contain the desired connection string and thus identify the consumer instances that comprise candidate consumer instances for a given provider instance.

Determine dependency instructions 134 may utilize a search command such as “Get all config-documents containing one-of(IPs) AND database_port AND database_sid” for a database type service provider wherein “IPs”, “database_port” and “database_sid” comprise variables to be replaced with configuration information extracted from each service provider instance's respective configuration settings. A database instance may comprise a connection string of 1.1.1.1:8080 with a session id (SID) of SQLDB-C. The search command may be updated with these values and the search “Get all config-documents containing one-of(1.1.1.1) AND 8080 AND SQLDB-C” may be run against the configuration files for consumer instances 150(A)-(C). In some implementations, the search command may use regular expressions and/or other search syntax such as may be compatible with an indexed database of consumer instance configuration files.

Method 200 may proceed to block 240 where device 100 may, in response to determining that the consumer instance is dependent on the at least one of the plurality of service provider instances, create an entry in a dependency map associating the consumer instance with the at least one of the service provider instances. For example, update dependency map instructions 136 may, in response to determining that one of the plurality of consumer instances is dependent on the one of the plurality of service provider instances, update a dependency map comprising the dependency of the one of the plurality of consumer instances on the one of the plurality of service provider instances. For example, update dependency map instructions may create a new entry associating consumer instance 150(A) with service provider instance 140(B) when the connection string from service provider instance 140(B) is located in the configuration file for consumer instance 150(A).

In some implementations, determining whether a consumer instance is dependent on the at least one of the plurality of service provider instances may comprise determining whether the consumer instance is within a search scope associated with the at least one of the plurality of service provider instances. The search scope may comprise criteria such as a text string, a consumer type, a consumer location, a network location, and/or a configuration setting. For example, the search scope may comprise a particular cluster of computers and/or a subnet of a network.

In some implementations, determining whether a consumer instance is dependent on the at least one of the plurality of service provider instances may comprise determining whether an element of the connection string appears in the indexed plurality of consumer instance configuration files and/or determining whether the element of the connection string appears in the configuration setting in a correct context. The context may be defined by a dependency signature rule applied to each of the candidate consumers.

For example, an IP address and port number for service provider instance 140(A) may appear in a configuration file for consumer instance 150(B), but a correct context may require that the IP address and port appear on the same line and/or as part of the same text string thereby providing a correct association between a first element (e.g., the IP address) of the connection string and a second element (e.g., the port number) of the connection string in the configuration setting. For another example, the dependency signature rule may ensure that the IP address and port number from the consumer instance configuration are associated with a correct database provider instance's SID and schema.

In some implementations, connection strings may be subject to override by different configuration files/settings. For example, a configuration document that exists on an individual server might override configuration documents that exist on a cluster to which the server belongs. In such cases, determine dependency instructions 134 may identify all of the files that might override the values, and apply the dependency signature rule to the one with the highest priority. In this example, the host's local configuration document may have a higher priority than the cluster document.

Method 200 may then end at block 250.

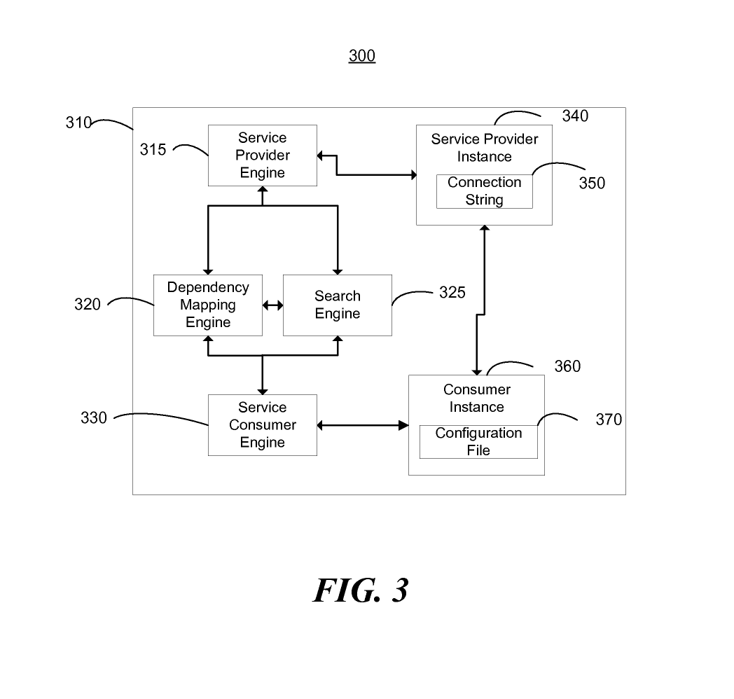

FIG. 3 is a block diagram of a system 300 for dependency mapping. System 300 may comprise a computing device 310 comprising a service provider engine 315, a dependency mapping engine 320, a search engine 325, a service consumer engine 330, a service provider instance 340 comprising a connection string configuration setting 350, and a consumer instance 360 comprising a configuration file 370. Computing device 310 may comprise, for example, a general and/or special purpose computer, server, mainframe, desktop, laptop, tablet, smart phone, game console, and/or any other system capable of providing computing capability consistent with providing the implementations described herein.

Each of engines 315, 320, 325, and 330 as well as instances 340 and 360 of system 300 may comprise any combination of hardware and instructions (e.g. programming) to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 315, 320, 325, and 330 as well as instances 340 and 360. In such examples, system 300 may comprise the machine-readable storage medium storing the instructions and the processing resource to execute the instructions, or the machine-readable storage medium may be separate but accessible to system 300 and the processing resource.

Service provider engine 315 may identify each of a plurality of service provider instances, such as service provider instance 340, wherein each of the service provider instances comprises one of a plurality of provider types, and extract a connection string, such as connection string 350, from a provider configuration setting associated with each of the plurality of service provider instances.

In some implementations, identify service provider instructions 130 may identify a plurality of service provider instances. For example, service provider types such as web servers, databases, middleware engines, directory services, etc. may be available on a server. Each of the service provider types may be associated with one and/or more service provider instances 140(A)-(C) and/or service provider instance 340.

In some implementations, a list of service provider types and/or service provider instances may be stored in configuration settings associated with identify service provider instructions 130. In some implementations, identify service provider instructions may search active processes on the server to identify which service provider instances are active.

In some implementations, identify service provider instructions 130 may extract a respective connection string from a configuration file associated with each of the plurality of service provider instances. Each service provider instance 140(A)-(C) may be associated with configuration settings such as connection strings, required parameters, identifiers, etc.

The connection string may comprise, for example, an IP address and port at which consumer instances 150(A)-(C), 360 may communicate with the service provider instances 140(A)-(C), 340. The configuration settings may, for example, be stored in a configuration file at a location known to be associated with the service provider type, such as an httpd.conf file stored in an/etc/httpd/directory. Such locations may comprise general configuration file directories for a server and/or may be service provider instance, service provider type, server, and/or operating system specific.

In some implementations, identify service provider instructions 130 may create a required relationship between the IP address and the port number. For example, the IP address and port may be associated such that both elements may comprise required search parameters.

In some implementations, the connection string for the at least one of the plurality of service provider instances may be extracted from a standard location according to a type of the at least one of the plurality of service provider instances.

Service consumer engine 330 may identify a consumer instance, such as consumer instance 360, associated with at least one of the plurality of provider types, and locate a configuration file, such as configuration file 370, associated with the consumer instance.

For example, identify consumer instance instructions 132 may identify consumer instances 150(A)-(C), 360 that interact with service provider instances 140(A)-(C), 340. In some implementations, a list of consumer types and/or consumer instances may be stored in configuration settings associated with identify consumer instructions 130. In some implementations, identify consumer instructions may search active processes on the server to identify which consumer instances are actively communicating with service provider instances 140(A)-(C), 340. For example, several web-based applications may comprise consumer instances 150(A)-(C), 360 and depend on a web server type service provider instance 140(B). For another example, several compiled applications may communicate with and depend upon a database type service provider instance 140(C). In some implementations, the configuration files for consumer instances 150(A)-(C), 360 may be indexed into a database compatible with a text search algorithm.

Search engine 325 may generate a search expression associated with the connection string for at least one of the plurality of service provider instances and determine whether the consumer instance comprises a candidate consumer for at least one of the plurality of service provider instances by applying the search expression applied to the configuration file. For example, search engine 325 may generate a regular expression search string comprising an IP address and port number from connection string 350 and use the search string to determine whether the IP address and port number elements of connection string 350 appear in configuration file 370. Upon locating elements of connection string 350 in configuration file 370, search engine 325 may determine that consumer instance 360 comprises a candidate consumer.

Search engine 325 may further determine, in response to determining that the consumer instance comprises the candidate consumer for the at least one of the plurality of service provider instances, determine whether the candidate consumer comprises an actual consumer according to a context of the connection string in the configuration file. For example, search engine 325 may determine whether the elements of connection string 350 appear in configuration file 370 associated with a correct service provider type and/or as part of the same configuration setting. In some cases, the IP address and port number from connection string 350 could appear in configuration file 370 in the wrong context, such as where the IP address and port number are in configuration file 370 but on different lines and associated with different services. For another example, a port number of 8080 could appear in configuration file 370 in a context other than that of a port number, such as part of an email address or other text string.

In some implementations, determine dependency instructions 134 may search configuration files for one and/or more of consumer instances 150(A)-(C), 360 to identify candidate consumers of a given service provider instance. Determine dependency instructions 134 may utilize a search command such as “Get all config-documents containing one-of(IPs) AND database_port AND database_sid” for a database type service provider wherein “IPs”, “database_port” and “database_sid” comprise variables to be replaced with configuration information extracted from each service provider instance's respective configuration settings. A database instance may comprise a connection string of 1.1.1.1:8080 with a session id (SID) of SQLDB-C. The search command may be updated with these values and the search “Get all config-documents containing one-of(1.1.1.1) AND 8080 AND SQLDB-C” may be run against the configuration files (e.g., configuration file 370) for consumer instances 150(A)-(C), 360. In some implementations, the search command may use regular expressions and/or other search syntax such as may be compatible with an indexed database of consumer instance configuration files.

Dependency mapping engine 320 may, in response to determining that the candidate consumer comprises the actual consumer, update an entry in a dependency map associating the consumer instance and the at least one of the plurality of service provider instances.

For example, update dependency map instructions 136 may, in response to determining that one of the plurality of consumer instances is dependent on the one of the plurality of service provider instances, update a dependency map comprising the dependency of the one of the plurality of consumer instances on the one of the plurality of service provider instances. For example, update dependency map instructions may create a new entry associating consumer instance 360 with service provider instance 340 when the connection string from service provider instance 340 is located in the configuration file for consumer instance 360.

In some implementations, determining whether a consumer instance is dependent on the at least one of the plurality of service provider instances may comprise determining whether the consumer instance is within a search scope associated with the at least one of the plurality of service provider instances. The search scope may comprise criteria such as a text string, a consumer type, a consumer location, a network location, and/or a configuration setting. For example, the search scope may comprise a particular cluster of computers and/or a subnet of a network.

In some implementations, determining whether a consumer instance is dependent on the at least one of the plurality of service provider instances may comprise determining whether an element of the connection string appears in the indexed plurality of consumer instance configuration files and/or determining whether the element of the connection string appears in the configuration setting in a correct context. For example, an IP address and port number for service provider instance 340 may appear in configuration file 370 for consumer instance 360, but a correct context may require that the IP address and port appear on the same line and/or as part of the same text string thereby providing a correct association between a first element (e.g., the IP address) of the connection string and a second element (e.g., the port number) of the connection string in the configuration setting.

The disclosed examples may include systems, devices, computer-readable storage media, and methods for dependency mapping. For purposes of explanation, certain examples are described with reference to the components illustrated in FIGS. 1-3. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions which, when executed by a processor, cause the processor to:
identify a plurality of service provider instances;
identify a plurality of consumer instances;
determine, according to a correlation between a configuration setting for each of the service provider instances and a configuration file for each of the plurality of consumer instances, whether one of the plurality of consumer instances is dependent on one of the plurality of service provider instances; and
in response to determining that one of the plurality of consumer instances is dependent on the one of the plurality of service provider instances, update a dependency map comprising the dependency of the one of the plurality of consumer instances on the one of the plurality of service provider instances.

2. The non-transitory machine-readable medium of claim 1, wherein the configuration setting for each of the plurality of service provider instances comprises a connection string.

3. The non-transitory machine-readable medium of claim 2, wherein the connection string comprises an IP address and a port number.

4. The non-transitory machine-readable medium of claim 3, wherein the instructions to identify the plurality of service provider instances comprise instructions to create a required relationship between the IP address and the port number.

5. The non-transitory machine-readable medium of claim 4, wherein the instructions to determine, according to the correlation between the configuration setting for each of the service provider instances and the configuration file for each of the plurality of consumer instances, whether the one of the plurality of consumer instances is dependent on the one of the plurality of service provider instances comprise instructions to determine whether the configuration file comprises the IP address and the port number.

6. The non-transitory machine-readable medium of claim 1, wherein the instructions to identify the plurality of service provider instances comprise instructions to extract a respective connection string from a configuration file associated with each of the plurality of service provider instances.

7. The non-transitory machine-readable medium of claim 1, wherein a location of the configuration file associated with each of the plurality of service provider instances is based on a type of each of the plurality of service providers.

8. A computer-implemented method comprising:
identifying a plurality of service provider instances;
extracting a connection string for at least one of the plurality of service provider instances;
indexing a plurality of consumer instance configuration files;
determining whether a consumer instance is dependent on the at least one of the plurality of service provider instances according to a search for the connection string in the indexed plurality of consumer instance configuration files; and
in response to determining that the consumer instance is dependent on the at least one of the plurality of service provider instances, creating an entry in a dependency map associating the consumer instance with the at least one of the service provider instances.

9. The computer-implemented method of claim 8, wherein determining whether a consumer instance is dependent on the at least one of the plurality of service provider instances comprises determining whether the consumer instance is within a search scope associated with the at least one of the plurality of service provider instances.

10. The computer-implemented method of claim 9, wherein the search scope comprises at least one of the following: a text string, a consumer type, a consumer location, a network location, and a configuration setting.

11. The computer-implemented method of claim 8, wherein determining whether a consumer instance is dependent on the at least one of the plurality of service provider instances comprises determining whether an element of the connection string appears in the indexed plurality of consumer instance configuration files.

12. The computer implemented method of claim 11, wherein determining whether the element of the connection string appears in the indexed plurality of consumer instance configuration files comprises determining whether the element of the connection string appears in the configuration setting in a correct context.

13. The computer-implemented method of claim 11, wherein the correct context comprises a correct association between the element of the connection string and a second element of the connection string in the configuration setting.

14. The computer-implemented method of claim 8, wherein the connection string for the at least one of the plurality of service provider instances is extracted from a standard location according to a type of the at least one of the plurality of service provider instances.

15. A system for dependency mapping, comprising:
a service provider engine to:
identify each of a plurality of service provider instances, wherein each of the service provider instances comprises one of a plurality of provider types, and
extract a connection string from a provider configuration setting associated with each of the plurality of service provider instances;
a service consumer engine to:
identify a consumer instance associated with at least one of the plurality of provider types, and
locate a configuration file associated with the consumer instance; and
a search engine to:
generate a search expression associated with the connection string for at least one of the plurality of service provider instances,
determine whether the consumer instance comprises a candidate consumer for at least one of the plurality of service provider instances by applying the search expression applied to the configuration file, and
in response to determining that the consumer instance comprises the candidate consumer for the at least one of the plurality of service provider instances, determine whether the candidate consumer comprises an actual consumer according to a context of the connection string in the configuration file; and
a dependency mapping engine to:
in response to determining that the candidate consumer comprises the actual consumer, update an entry in a dependency map associating the consumer instance and the at least one of the plurality of service provider instances.
